(19) United States
(12) Patent Application Publication
(10) Pub. No.: US 2026/0135703 A1
(43) Pub. Date: May 14, 2026

(54) Asynchronous Cryptographic Key Caching and Generation

(71) Applicant: Google LLC, Mountain View, CA (US)

(72) Inventors: Matthew John Stevenson, Mountain View, CA (US); Michael Schiffman, Moraga, CA (US); Sophie Schmieg, Santa Clara, CA (US); Chet Edward Stuut, Western Springs, IL (US); Jon McCarrell McCune, Sunnyvale, CA (US)

(21) Appl. No.: 18/948,291

(22) Filed: Nov. 14, 2024

(51) Int. Cl. H04L 9/08

(52) U.S. Cl. CPC H04L 9/0894; H04L 9/0861

(57) ABSTRACT

Provided are systems and methods for generating and caching cryptographic keys to secure communications. Specifically, the method involves generating a unique ephemeral keyset, which includes a public and a private key, for each key re-use period by a computing system. This keyset is stored in a memory cache and is used to initiate or resume secure communication sessions with other computing systems until the key re-use period expires. Upon expiration, the keyset is deleted from the cache.

### FIELD

The present disclosure relates generally to secured communications protocols. More particularly, aspects of the present disclosure relate to generating and caching an ephemeral keyset for re-use during a key re-use period.

### BACKGROUND

Computing devices can engage in secure communications through the use of cryptographic protocols. A sender device and a receiver device can initiate an encrypted communication stream by conducting a “handshake” sequence in which the devices agree on an encryption scheme and exchange information so that each device can decrypt messages encrypted by the other.

A common method of encryption utilizes a Triple Diffie Hellman Cipher (3DH). Communication protocols using keys with a 3DH encryption provide increased protection against Key Compromise Impersonation (KCI) vulnerabilities. However, 3DH protocols can caused increased latency which may delay secure communications sessions and/or consume additional computational resources.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method to perform periodic generation and caching of cryptographic keys for re-use with multiple communication sessions. The computer-implemented method can be performed for each of a plurality of key re-use periods. The method includes generating, by a first computing system, and in response to an initiation of the key re-use period, a current ephemeral keyset which may include an ephemeral public key and an ephemeral private key. The method also includes storing, by the first computing system, the current ephemeral keyset in a memory cache. The method also includes using, by the first computing system, and until an expiration of the key re-use period, the current ephemeral keyset to initiate or resume one or more secure communication sessions with one or more other computing systems. Other embodiments of this aspect include corresponding computer systems, apparatus, and computer programs recorded on one or more computer storage devices, each configured to perform the actions of the methods.

One general aspect includes a first computing system configured to perform operations for periodic generation and caching of cryptographic keys for re-use with multiple communication sessions. The first computing system can perform operations for each of a plurality of key re-use periods. The operations can include generating, by the first computing system, and in response to an initiation of the key re-use period, a current ephemeral keyset may include an ephemeral public key and an ephemeral private key. The operations can include storing, by the first computing system, the current ephemeral keyset in a memory cache. The operations can include using, by the first computing system, and until an expiration of the key re-use period, the current ephemeral keyset to initiate or resume one or more secure communication sessions with one or more other computing systems. Other embodiments of this aspect include corresponding computer systems, apparatus, and computer programs recorded on one or more computer storage devices, each configured to perform the actions of the methods.

### BRIEF DESCRIPTION OF THE DRAWINGS

Detailed discussion of embodiments direct to one of ordinary skill in the art is set forth in the specification, which makes reference to the appended figures, in which:

FIG. 1 is a swim lane diagram of example systems performing secure communications sessions according to example aspects of some embodiments of the present disclosure;

FIG. 2 is a swim lane of example systems performing secure communications sessions according to example aspects of some embodiments of the present disclosure;

FIG. 3 is a swim lane of example systems performing secure communications sessions according to example aspects of some embodiments of the present disclosure;

FIG. 4 is a swim lane diagram of example systems performing secure communications sessions according to example aspects of some embodiments of the present disclosure;

FIG. 5 is a swim lane diagram of example systems performing secure communications sessions according to example aspects of some embodiments of the present disclosure;

FIG. 6 is a flow chart diagram of an example method for implementing techniques according to various aspects of some embodiments of the present disclosure;

FIG. 7 is a swim lane diagram showing example systems implementing techniques according to various aspects of some embodiments of the present disclosure;

FIG. 8 is a block diagram of an example computing system implementing techniques according to example aspects of some embodiments of the present disclosure;

Reference numerals that are repeated across plural figures are intended to identify the same features in various implementations.

### DETAILED DESCRIPTION

Example aspects of the present disclosure are directed to systems and methods for asynchronously generating and caching ephemeral cryptographic keys to enhance the efficiency of secure communication sessions. In particular, a computing system can operate over a plurality of key re-use periods. During each key re-use period, the computing system can generate a new ephemeral keyset, store the ephemeral keyset to a memory cache, and then re-use this keyset to initiate or resume one or more secure communication sessions with one or more other computing systems. For example, the same ephemeral keyset can be used to initiate or resume multiple different secure communication sessions with multiple different computing systems during the key re-use period. Upon the expiration of a key re-use period, the computing system can delete the ephemeral keyset and then begin a new key re-use period with a new ephemeral keyset. The re-use of cryptographic keys for a re-use period can result in reduced consumption of computational resources, for example as compared to prior approaches which would generate an entirely new ephemeral keyset for each different communication session.

More particularly, a computing system can perform cryptographic key management over a plurality of key re-use periods. For example, the key re-use periods can be sequential and non-overlapping. The key re-use periods may have a fixed or pre-defined temporal duration (e.g., some pre-defined number of minutes), or the length of the key re-use periods may be dynamically determined based on various factors such as available computational resources, current network traffic volume, a reported cybersecurity risk level, etc. For instance, in systems where security is a higher priority, shorter key re-use periods can be employed to enhance the cryptographic strength of the connections. Conversely, in systems where computational resources are at a premium, longer key re-use periods might be used to reduce the frequency of key generation and thus lower the computational load on the system.

The initiation of each key re-use period can include generating a new set of ephemeral keys, which may include one or several public keys and one or several private keys. For example, a server can generate these keys using various cryptographic algorithms for cryptographic key generation. Once generated, this current set of keys can be stored in a memory cache, which can, for example, be implemented using various caching mechanisms such as in-memory databases. In some examples, the memory cache can be a non-persistent memory cache, such as a cache stored in Random Access Memory (RAM). This storage of the keyset in a memory cache allows for quick retrieval and use of the keys, thereby improving the performance of the key exchange process during secure session initiation.

The ephemeral keyset may be various types of keysets, such as an elliptic curve digital signature algorithm (ECDSA) keyset, a post-quantum computing (PQC) keyset, etc. Thus, in some implementations, the computing system may perform a post-quantum cryptographic algorithm to generate a current post-quantum cryptographic keyset.

According to an aspect of the present disclosure, during the pendency of each key re-use period, the current set of cryptographic keys can be re-used to initiate or resume one or more secure communications sessions involving one or more other, different computing systems. This can be particularly advantageous in distributed systems or cloud environments where multiple instances or services need to establish secure connections frequently and swiftly. By re-using the same set of keys for multiple sessions, the system can avoid the overhead associated with frequent key generations.

In some implementations, generating the keyset at the initiation of each key re-use period can include serializing each ephemeral public key to generate one or more serialized public keys. These serialized versions of the keys can then be stored in the memory cache. This serialized form of the public key can then be transmitted to other computing systems as part of the secure session initiation process.

In some implementations, the computing system can re-use the same current ephemeral keyset to engage in secure communications sessions with multiple different computing systems. Each of these different systems can have its own different and respective set of ephemeral keys and manage them according to their own key re-use periods. In some implementations, the different computing systems can operate to rotate their keys asynchronously, meaning that each system can independently manage its key re-use periods without synchronization with other systems. In other cases, it is possible for the different computing systems to have synchronized key re-use periods.

Upon the expiration of each key re-use period, the computing system can securely delete the expired ephemeral keys from the memory cache. This can be achieved through various data sanitization techniques such as overwriting the memory locations with zeros or random data, which helps in preventing unauthorized recovery and use of the old keys.

Thus, the computing system in response to the expiration of the key re-use period may delete the current ephemeral keyset from the memory cache. The computing system in response to the expiration of the key re-use period may also generate and store a second ephemeral keyset for a second key re-use period. The computing system may have a new pre-defined temporal length for the second key re-use period or the same pre-defined temporal length for the second key re-use period.

Furthermore, the computing system can deny any attempts to initiate or resume a secure communication session using prior ephemeral keysets associated with an expired key re-use periods. For example, this can be implemented using timestamp checks or session tokens that validate the currency of the ephemeral keys being used. This measure prevents the reuse of old keys and ensures that each secure communications session is secured with only currently valid keyset associated with the current key re-use period.

In some examples, the secure communications sessions can be or leverage mutual authentication and transport encryption protocols. The secure communications sessions can include newly initiated communications sessions or resumed communications sessions. The communication sessions can include a full handshake or a partial handshake. A secure communications session can include one or more messages sent from a first computing system to one or more other computing systems. A secure communications session can include one or more messages sent from one or more other computing systems to a first computing system and/or one or more other computing systems.

After some period of time, the secure communications session may pause, terminate, expire, etc. To resume the encrypted session after a period of time the first computing system and the second computing system may reestablish the communications session using the current ephemeral keyset, without performing a full handshake.

The systems and methods of the present disclosure provide a number of technical effects and benefits. As one example, the proposed technology significantly enhances the efficiency of computational resources by re-using cryptographic keysets for multiple secure communications sessions within defined key re-use periods. This method reduces the computational burden typically associated with generating new keysets for each individual session, which is a common practice in existing systems.

As another example technical effect and benefit, the proposed techniques dynamically determine the length of key re-use periods based on factors such as network traffic volume and cybersecurity risk levels showcases an adaptive technical feature. This adaptability ensures optimal performance and enhanced security tailored to real-time conditions, which is a improvement over static systems.

Thus, the proposed technology employs a method that improves the efficiency of computational resources by allowing for the re-use of cryptographic keysets during predefined periods. This approach not only reduces the frequency of key generation but also minimizes the computational load, addressing a core technical challenge in secure communications.

Various example implementations are described herein with respect to the accompanying Figures.

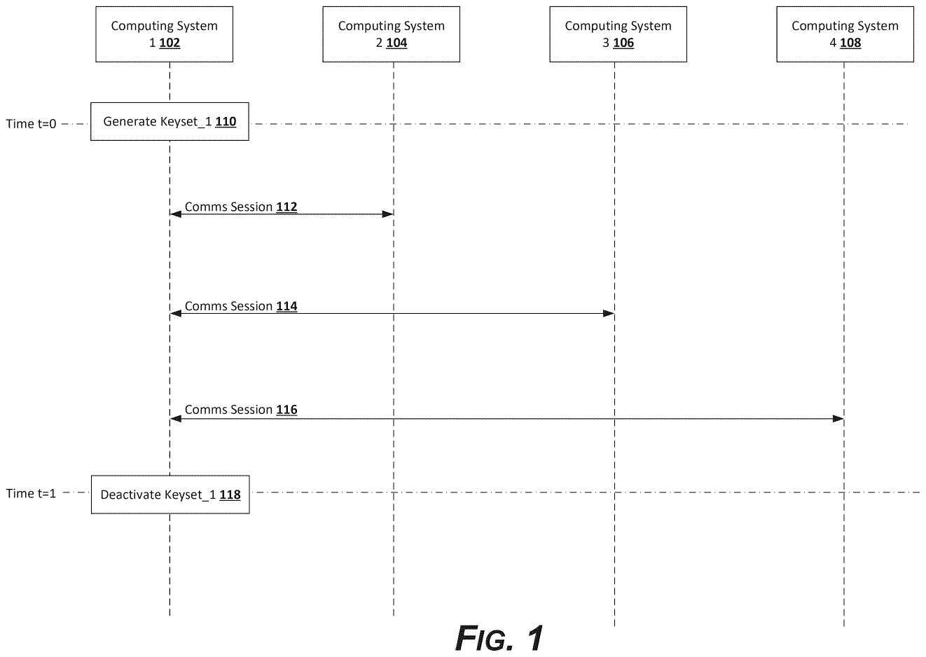

FIG. 1 is a swim lane diagram of example systems configured to re-use current ephemeral keysets during a key re-use period according to aspects of the present disclosure. A first computing system 102 and a second computing system 104 can communicate. The first computing system 102 and a third computing system 106 can communicate. The first computing system 102 and a fourth computing system 108 can communicate.

First computing system 102 and second computing system 104 can communicate over a network connection or any other type of connection channel. First computing system 102 and third computing system 106 can communicate over a network connection or any other type of connection channel. First computing system 102 and fourth computing system 108 can communicate over a network connection or any other type of connection channel.

Second computing system 104, third computing system 106 and fourth computing system 108 can communicate. Second computing system 104, third computing system 106 and fourth computing system 108 can communicate over a network connection or any other type of connection channel.

A first computing system 102 may generate a first ephemeral keyset 110 in response to a request for and/or initiation of a key re-use period. The first computing system 102 can generate the first ephemeral keyset 110 using cryptographic algorithms, which can include, for example, RSA, DSA, or ECC algorithms. The choice of algorithm can depend on the required security level and computational resources available. The memory cache in the first computing system 102 can store the first ephemeral keyset 110. This memory cache can be implemented using technologies such as DRAM or SRAM, which can provide fast access times to enhance the performance of the key retrieval process.

The first computing system 102 and a second computing system 104 may initiate or resume a secure communications session 112 using the first ephemeral keyset. The secure communications session 112 initiated or resumed by the first computing system 102 using the first ephemeral keyset 110 can employ protocols such as TLS or SSL. These protocols can ensure the confidentiality and integrity of the data exchanged during the session.

The first computing system 102 may initiate or resume a secure communications session 114 with a third computing system 106 using the first current ephemeral keyset. Alternatively or additionally, a fourth computing system 108 may initiate or resume a secure communications session 116 with the first computing system using the first current ephemeral keyset.

The current ephemeral keyset may be used by one or more computing systems during the key re-use period. The key re-use period may comprise a plurality of seconds, minutes, or hours.

At the expiration of the key re-use period the first computing system 102 deactivates, deletes, or deauthorizes the first ephemeral keyset 118. Thereafter, the first ephemeral keyset can not be used to initiate or resume a secure communications session. For example, upon the expiration of the key re-use period, the first computing system 102 can deactivate the first ephemeral keyset 118 using methods such as overwriting the key data with zeros or random values to prevent unauthorized access or recovery of the key information.

In some example implementations which use a post-quantum cipher, the first computing system creates a post-quantum current keyset. The post-quantum cipher current keyset (PQCKP), may be sent to one or more computing systems in response to a request to initiate or resume a secure communication session. The PQCKP may be active for a plurality of seconds, minutes or hours, depending on various factors such as available computational resources, current network traffic volume, a reported cybersecurity risk level, etc. For instance, in systems where security is a higher priority, shorter key re-use periods can be employed to enhance the cryptographic strength of the connections.

Conversely, in systems where computational resources are at a premium, longer key re-use periods might be used to reduce the frequency of key generation and thus lower the computational load on the system. When the key re-use period expires the PQCKP will expire. The system may delete the PQCKP from its memory cache. The system may generate another PQCKP for a following key re-use period.

In some example implementations, one or more computing systems in a secure communications session may disconnect from the session due to an error or one computing system losing an internet or Local Area Network (LAN) connection. The computing system that lost the connection may rejoin the secure communications session using the first ephemeral keyset, where the key re-use period has not expired and the one or more computing systems have the first ephemeral keyset stored in a memory cache.

Further, in some implementations, the one or more computing systems may rejoin the secure communications session multiple times in the case of interrupted internet connections with the first ephemeral keyset during the first key re-use period. At the end of the key re-use period the one or more computing systems may delete the first ephemeral keyset from their memory caches and/or the first ephemeral keyset may not be used to resume or rejoin the secure communications session.

In one example implementation that uses the current ephemeral keyset, the first computing system initiates or resumes one or more authentication and transport encryption protocols.

One example implementation is the second computing system storing at least a portion of the first ephemeral keyset (e.g., the serialized public key) in a memory cache, during the first key re-use period, and in response to a request to join the secure communications session, the second computing system sends a third computing system the first ephemeral keyset, wherein the first ephemeral keyset is the current ephemeral keyset. The third computing system may join the established secure communications session with the first computing system and the second computing system using the portion of the first ephemeral keyset.

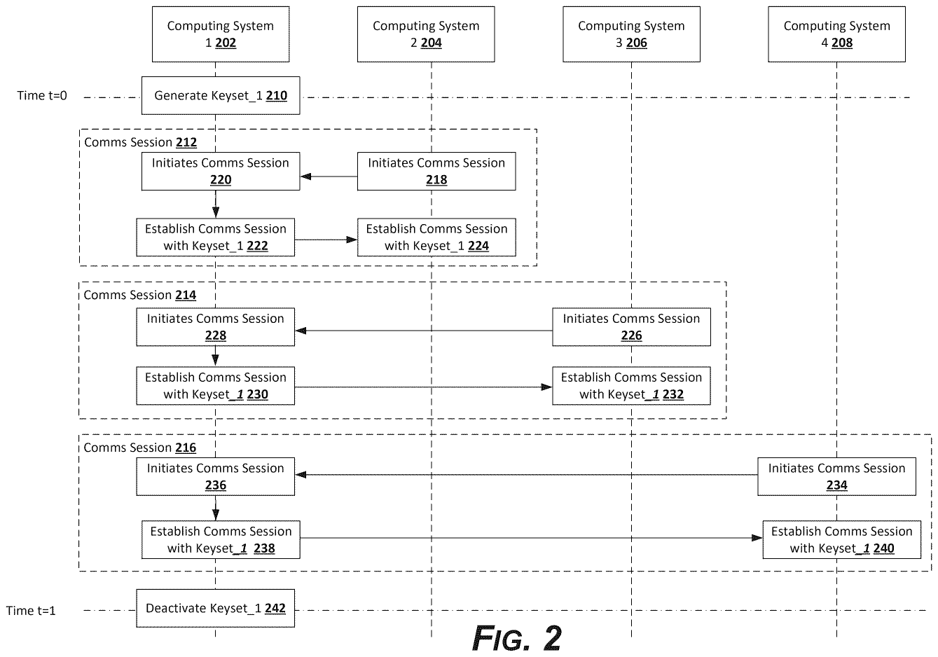

FIG. 2 is a swim lane diagram of an example system configured to re-use current ephemeral keysets during a key re-use period according to aspects of the present disclosure.

A first computing system 202 and a second computing system 204 can communicate. First computing system 202 and second computing system 204 can communicate over a network connection or any other type of connection channel.

The first computing system 202 and a third computing system 206 can communicate. The first computing system 202 and a fourth computing system 208 can communicate. First computing system 202 and second computing system 204 can communicate over a network connection or any other type of connection channel.

First computing system 202 and third computing system 206 can communicate over a network connection or any other type of connection channel. First computing system 202 and fourth computing system 208 can communicate over a network connection or any other type of connection channel.

In response to an initiation of a key re-use period (e.g., as triggered by a clock or other periodic control logic), a first computing system 202 generates a first ephemeral keyset 210. The first computing system 202 can generate the first ephemeral keyset 210 using cryptographic algorithms such as RSA or ECC, which can be selected based on the security requirements and computational capabilities of the first computing system 202. The memory cache in the first computing system 202 can store the first ephemeral keyset 210 using encryption techniques to ensure the security of the keys while they reside in the cache. In some implementations, upon the initiation of a key re-use period, the first computing system 202 can employ a timer or event-based trigger to start the process of generating the first ephemeral keyset 210.

The second computing system 204 initiates or resumes a secure communications session 218 with the first computing system 220 using the first current ephemeral keyset, which the first computing system 202 may use to establish a secure communications session 222 with the second computing system 224. The secure communications session 218 between the first computing system 202 and the second computing system 204 can be established using protocols such as TLS or SSL, which can ensure the confidentiality and integrity of the data exchanged during the session. In some implementations, the second computing system 204 can request to initiate or resume the secure communications session 218 by sending a digitally signed request to the first computing system 202, which can verify the authenticity of the request before proceeding.

During the key re-use period, a third computing system 206 may initiate or resume a secure communications session 214, 226 with the first computing system 228, the first computing system 202 may establish the secure communications session using the first current ephemeral keyset 230 with the third computing system 232.

A fourth computing system 208 may also initiate or resume a secure communications session 216 with the first computing system 236, where the first computing system 202 may establish the secure communications session 238 using the first current ephemeral keyset with the fourth computing system 240.

During the key re-use period, one or more computing systems may initiate communications with the first computing system 202 using the first current ephemeral keyset. At the expiration of the key re-use period, the first current ephemeral keyset will be deactivated by the first computing system 242.

One example implementation is using a post-quantum cipher, the first computing system creates a post-quantum current keyset. The post-quantum cipher current keyset (PQCKP), may be sent to one or more computing systems in response to a request to initiate or resume a secure communication session. The PQCKP may be active for a plurality of seconds, minutes or hours, depending on various factors such as available computational resources, current network traffic volume, a reported cybersecurity risk level, etc. For instance, in systems where security is a higher priority, shorter key re-use periods can be employed to enhance the cryptographic strength of the connections.

Conversely, in systems where computational resources are at a premium, longer key re-use periods might be used to reduce the frequency of key generation and thus lower the computational load on the system. When the key re-use period expires the PQCKP will expire. The system may delete the PQCKP from its memory cache. The system may generate another PQCKP.

One example implementation is one or more computing systems in a secure communications session disconnect due to an error or one computing system losing an internet or LAN connection. The computing system that lost the connection may rejoin the secure communications session using the first ephemeral keyset, where the key re-use period has not expired and the one or more computing systems have the first ephemeral keyset stored in a memory cache. The one or more computing systems may rejoin the secure communications session multiple times in the case of interrupted internet connections with the first ephemeral keyset during the first key re-use period. Another example implementation is, using the current ephemeral keyset, the first computing system initiates or resumes one or more authentication and transport encryption protocols.

At the end of the key re-use period the one or more computing systems may delete the first ephemeral keyset from their memory caches. The process for securely deleting the first ephemeral keyset 210 from the memory cache of the first computing system 202 can include overwriting the key data with random values or employing secure deletion protocols to prevent unauthorized recovery of the keyset. Furthermore, during the key re-use period, the first computing system 202 can monitor for conditions that may require the premature termination of the key re-use period, such as detection of a security breach or system malfunction, and respond by initiating the generation of a new ephemeral keyset.

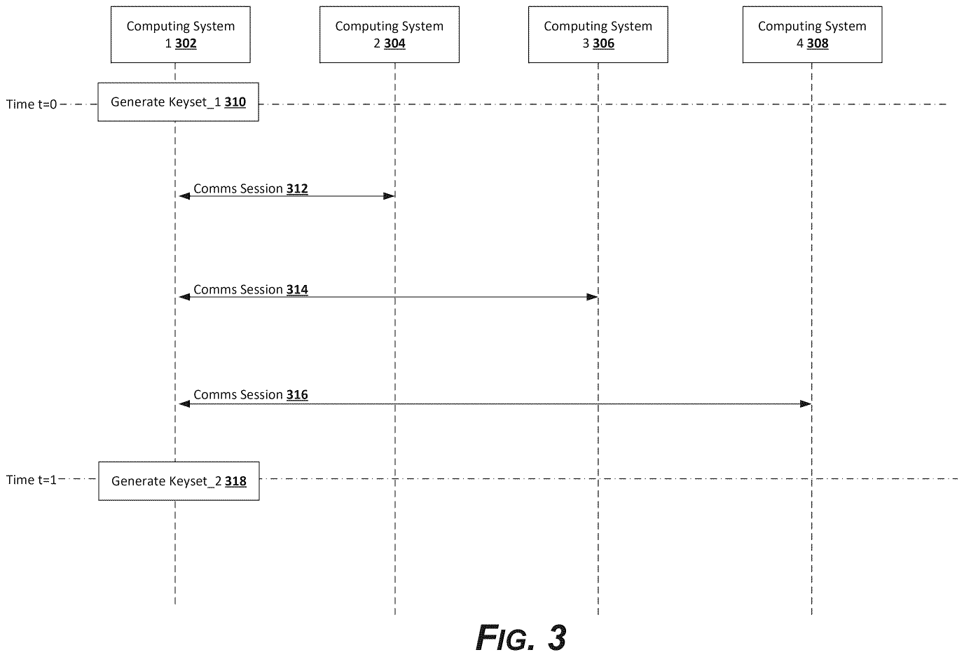

FIG. 3 is a swim lane diagram of example systems configured to re-use current ephemeral keysets during a key re-use period according to aspects of the present disclosure. A first computing system 302 and a second computing system 304 can communicate. First computing system 302 and second computing system 304 can communicate over a network connection or any other type of connection channel. The first computing system 302 and a third computing system 306 can communicate. The first computing system 302 and a fourth computing system 308 can communicate.

First computing system 302 and second computing system 304 can communicate over a network connection or any other type of connection channel. First computing system 302 and third computing system 306 can communicate over a network connection or any other type of connection channel. First computing system 302 and fourth computing system 308 can communicate over a network connection or any other type of connection channel. Second computing system 304, third computing system 306 and fourth computing system 308 can communicate. Second computing system 304, third computing system 306 and fourth computing system 308.

In response to an initiation of a key re-use period, a first computing system 302 may generate a first ephemeral keyset 310. For example, the first computing system 302 can generate a first ephemeral keyset 310 which can include various cryptographic algorithms such as RSA, ECC, or AES for key generation. The specific algorithm used can depend on the security requirements and computational resources available to the first computing system 302.

Using the first current ephemeral keyset the first computing system 302 and a second computing system 304 may initiate or resume a secure communications session 312. The secure communications session 312 initiated or resumed by the first computing system 302 and the second computing system 304 can utilize protocols such as SSL/TLS or IPSec, which can be selected based on the type of data being transmitted and the level of security required.

The first computing system 302 may initiate or resume a secure communications session 314 with a third computing system 306 using the first current ephemeral keyset. Additionally or alternatively, fourth computing system 308 may initiate or resume a secure communications session 316 with the first computing system using the first current ephemeral keyset.

Thus, in some implementations, during the key re-use period, the first computing system 302 can allow an unlimited number of secure communications sessions to be initiated or resumed using the first current ephemeral keyset 310, as long as the key re-use period has not expired. This can include communications with additional computing systems beyond the second computing system 304, third computing system 306, and fourth computing system 308, which can also be part of a larger distributed network.

At the expiration of the key re-use period the first computing system 302 generates a second ephemeral keyset 318. The second ephemeral keyset 318 generated by the first computing system 302 at the expiration of the key re-use period can use a different cryptographic algorithm or key length from the first ephemeral keyset 310, depending on the current security landscape and technological advancements at the time of generation. This can provide adaptive security measures based on evolving threats.

Any computing system with the first ephemeral keyset can no longer access the secure communications session. Any computing system with the second ephemeral keyset may access the secure communications session during the period where the second ephemeral keyset is the current keyset.

Thus, during the key re-use period any number of computing systems may initiate or resume a secure communications session with the first computing system 302 using the first current ephemeral keyset. At the expiration of the key re-use period, the second current ephemeral keyset must be used to initiate or resume one or more secure communications sessions with the first computing system, until the expiration of a second key re-use period.

The current ephemeral keyset may be used by one or more computing systems during the key re-use period. The key re-use period may comprise a plurality of seconds, minutes or hours.

One example implementation is using a post-quantum cipher, the first computing system creates a post-quantum current keyset. The post-quantum cipher current keyset (PQCKP), may be sent to one or more computing systems in response to a request to initiate or resume a secure communication session. The PQCKP may be active for a plurality of seconds, minutes or hours, depending on various factors such as available computational resources, current network traffic volume, a reported cybersecurity risk level, etc. For instance, in systems where security is a higher priority, shorter key re-use periods can be employed to enhance the cryptographic strength of the connections.

Conversely, in systems where computational resources are at a premium, longer key re-use periods might be used to reduce the frequency of key generation and thus lower the computational load on the system. When the key re-use period expires the PQCKP will expire. The system may delete the PQCKP from its memory cache. The system may generate another PQCKP.

One example implementation is one or more computing systems in a secure communications session disconnect due to an error or one computing system losing an internet or LAN connection. The computing system that lost the connection may rejoin the secure communications session using the first ephemeral keyset, where the key re-use period has not expired and the one or more computing systems have the first ephemeral keyset stored in a memory cache. The one or more computing systems may rejoin the secure communications session multiple times in the case of interrupted internet connections with the first ephemeral keyset during the first key re-use period. Another example implementation is, using the current ephemeral keyset, the first computing system initiates or resumes one or more authentication and transport encryption protocols.

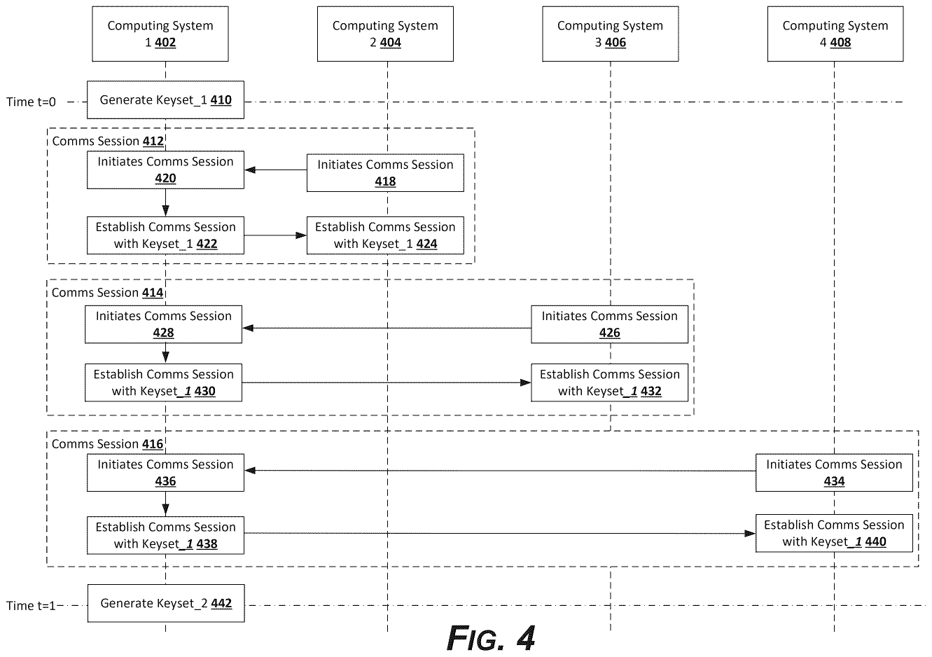

FIG. 4 is a swim lane diagram of example systems configured to re-use current ephemeral keysets during a key re-use period according to aspects of the present disclosure. A first computing system 402 and a second computing system 404 can communicate. First computing system 402 and second computing system 404 can communicate over a network connection or any other type of connection channel. The first computing system 402 and a third computing system 406 can communicate. The first computing system 402 and a fourth computing system 408 can communicate. First computing system 402 and second computing system 404 can communicate over a network connection or any other type of connection channel. First computing system 402 and third computing system 406 can communicate over a network connection or any other type of connection channel. First computing system 402 and fourth computing system 408 can communicate over a network connection or any other type of connection channel. Second computing system 404, third computing system 406 and fourth computing system 408 can communicate. Second computing system 404, third computing system 406 and fourth computing system 408.

In response to a request for a key re-use period, a first computing system 402 may generate a first current ephemeral keyset. For example, the first computing system 402 can generate the first current ephemeral keyset using cryptographic algorithms such as RSA or ECC.

A second computing system 404 may initiate or resume a secure communications session 418 with the first computing system 420, where the first computing system may establish the secure communications session 422 with the second computing system 424 using the first current ephemeral keyset. For example, the second computing system 404 can initiate or resume a secure communications session 418 with the first computing system 420 by sending a request over a secure protocol like HTTPS or TLS. For example, the first computing system 402 can establish the secure communications session 422 using the first current ephemeral keyset, which can include transmitting the serialized public key to the second computing system 424.

A third computing system 406 may initiate or resume a secure communications session 426 with the first computing system 428, where the first computing system may establish the secure communications session 430 with the third computing system 432 using the first current ephemeral keyset. For example, the third computing system 406 can use a similar protocol to initiate or resume a secure communications session 426 with the first computing system 428, where the secure communications session 430 can be established using the same first current ephemeral keyset.

A fourth computing system 408 may initiate or resume a secure communications session 434 with the first computing system 436, where the first computing system may establish the secure communication session 438 with the fourth computing system 440 using the first current ephemeral keyset. For example, the fourth computing system 408 can also engage in a secure communications session 434 with the first computing system 436, and the secure communications session 438 can be established using the same first current ephemeral keyset.

After the key re-use period has expired, the first computing system 402 may generate a second current ephemeral keyset 442, where the first current ephemeral keyset has expired and the second current ephemeral keyset must be used to initiate or resume one or more secure communications sessions until the expiration of a second key re-use period. One or more computing systems may be used to initiate or resume one or more secure communications sessions during the key re-use period, using the current ephemeral keyset.

For example, after the key re-use period has expired, the first computing system 402 can generate a second current ephemeral keyset 442 using a different or the same cryptographic algorithm, depending on the desired security level and computational resources available. For example, the second current ephemeral keyset 442 must then be used by the first computing system 402 and any other computing systems wishing to communicate securely with it until the expiration of a second key re-use period.

One example implementation is using a post-quantum cipher, the first computing system creates a post-quantum current keyset. The post-quantum cipher current keyset (PQCKP), may be sent to one or more computing systems in response to a request to initiate or resume a secure communication session. The PQCKP may be active for a plurality of seconds, minutes or hours, depending on various factors such as available computational resources, current network traffic volume, a reported cybersecurity risk level, etc. For instance, in systems where security is a higher priority, shorter key re-use periods can be employed to enhance the cryptographic strength of the connections.

Conversely, in systems where computational resources are at a premium, longer key re-use periods might be used to reduce the frequency of key generation and thus lower the computational load on the system. When the key re-use period expires the PQCKP will expire. The system may delete the PQCKP from its memory cache. The system may generate another PQCKP.

One example implementation is one or more computing systems in a secure communications session disconnect due to an error or one computing system losing an internet or LAN connection. The computing system that lost the connection may rejoin the secure communications session using the first ephemeral keyset, where the key re-use period has not expired and the one or more computing systems have the first ephemeral keyset stored in a memory cache. The one or more computing systems may rejoin the secure communications session multiple times in the case of interrupted internet connections with the first ephemeral keyset during the first key re-use period. Another example implementation of this is using the current ephemeral keyset, the first computing system initiates or resumes one or more authentication and transport encryption protocols.

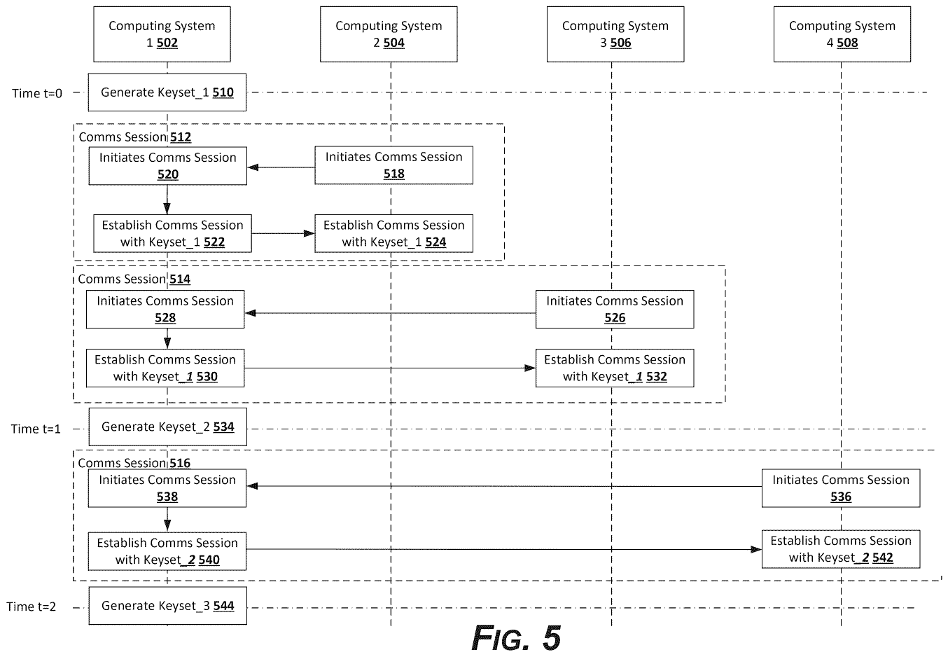

FIG. 5 is a block diagram of an example system configured to re-use current ephemeral keysets during a key re-use period according to aspects of the present disclosure. A first computing system 502 and a second computing system 504 can communicate. First computing system 502 and second computing system 504 can communicate over a network connection or any other type of connection channel. The first computing system 502 and a third computing system 506 can communicate. The first computing system 502 and a fourth computing system 508 can communicate. First computing system 502 and second computing system 504 can communicate over a network connection or any other type of connection channel. First computing system 502 and third computing system 506 can communicate over a network connection or any other type of connection channel. First computing system 502 and fourth computing system 508 can communicate over a network connection or any other type of connection channel. Second computing system 504, third computing system 506 and fourth computing system 508 can communicate. Second computing system 504, third computing system 506 and fourth computing system 508.

In response to a request for a key re-use period, a first computing system 502 may generate a first current ephemeral keyset 510. A second computing system 504 may initiate or resume a secure communications session 518 with the first computing system 520, where the first computing system 502 may establish the secure communications session 522 using the first current ephemeral keyset.

A third computing system 506 may initiate or resume a secure communications session 526 with the first computing system 524, where the first computing system 502 may establish the secure communications session 530 using the first current ephemeral keyset.

After the key re-use period has ended, the first computing system 502 may generate a second current ephemeral keyset 534. Where the first current ephemeral keyset has expired and the second current ephemeral keyset must be used to initiate or resume one or more secure communications sessions, until the expiration of a second key re-use period.

A fourth computing system 508 may initiate or resume a secure communications session 536 with the first computing system 538 and the first computing system may establish the secure communications session using the second current ephemeral keyset 540.

After the second key re-use period has expired, the first computing system 502 may generate a third current ephemeral keyset 544. Where the first current ephemeral keyset and the second current ephemeral keyset has expired and the third current ephemeral keyset must be used to initiate or resume the one or more secure communications sessions, until the expiration of a third key re-use period. Any number of computing systems may be used to initiate or resume the one or more secure communications sessions during the key re-use period, using the current keyset.

One example implementation of this is using a post-quantum cipher, the first computing system creates a post-quantum current keyset. The post-quantum cipher current keyset (PQCKP), may be sent to one or more computing systems in response to a request to initiate or resume a secure communication session. The PQCKP may be active for a plurality of seconds, minutes or hours, depending on various factors such as available computational resources, current network traffic volume, a reported cybersecurity risk level, etc. For instance, in systems where security is a higher priority, shorter key re-use periods can be employed to enhance the cryptographic strength of the connections. Conversely, in systems where computational resources are at a premium, longer key re-use periods might be used to reduce the frequency of key generation and thus lower the computational load on the system. When the key re-use period expires the PQCKP will expire. The system may delete the PQCKP from its memory cache. The system may generate another PQCKP.

One example implementation of this is one or more computing systems in a secure communications session disconnect due to an error or one computing system losing an internet or LAN connection. The computing system that lost the connection may rejoin the secure communications session using the first ephemeral keyset, where the key re-use period has not expired and the one or more computing systems have the first ephemeral keyset stored in a memory cache. The one or more computing systems may rejoin the secure communications session multiple times in the case of interrupted internet connections with the first ephemeral keyset during the first key re-use period.

One example implementation of this is using the current ephemeral keyset, the first computing system initiates or resumes one or more authentication and transport encryption protocols.

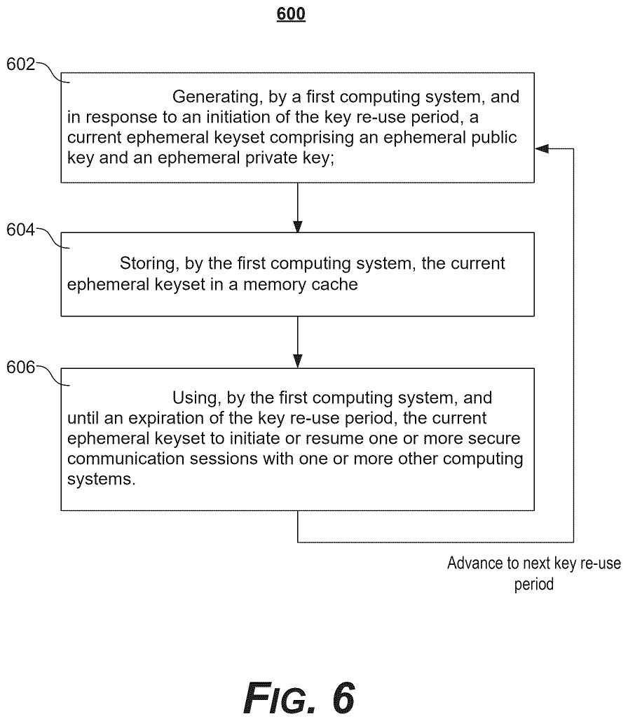

FIG. 6 is a flow chart diagram of an example system configured to re-use current ephemeral keysets during a key re-use period according to aspects of the present disclosure. A first computing system and a second computing system can communicate. First computing system and second computing system can communicate over a network connection or any other type of connection channel.

At 602, in response to an initiation of a key re-use period, a first computing system may generate a current ephemeral keyset comprising an ephemeral public key and an ephemeral private key. At 604, the first computing system may store the current ephemeral keyset in the memory cache. For example, the first computing system may store the serialized public key in the memory cache at 604. At 606, the first computing system may use the current ephemeral keyset, until the expiration of the key re-use period, to initiate or resume one or more secure communications sessions with the one or more other computing systems. For example, using the current keyset at 606 can include transmitting, by the first computing system, the serialized public key to the one or more other computing systems. At the expiration of the key re-use period, the first computing system can delete or otherwise deactivate the keyset. The first computing system can then return to 604 and begin a new key re-use period.

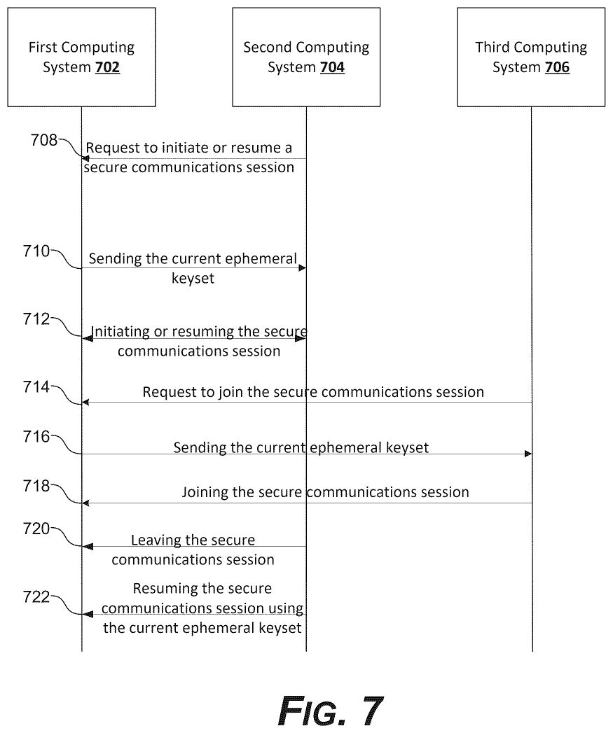

FIG. 7 is a swim lane diagram of example systems configured to re-use current ephemeral keysets during a key re-use period according to aspects of the present disclosure. A first computing system 502 and a second computing system 504 can communicate. First computing system 502 and second computing system 504 can communicate over a network connection or any other type of connection channel.

A second computing system 704 may request to initiate or resume a secure communications session 708 with a first computing system 702. The first computing system 702 may send at least a portion of a current ephemeral keyset to the second computing system 710. The first computing system or the second computing system may, using the current ephemeral keyset, initiate or resume the secure communications session between the first and second computing systems 712.

A third computing system 706 may request to join the secure communications session between the first and second computing systems 714. The first computing system 702, in response to the request, may send the current ephemeral keyset to the third computing system 716. Where the third computing system joins the secure communications session between the first and second computing systems 718.

The second computing system 704 may leave the secure communications session 720. The second computing system may resume the secure communications session using the current ephemeral keyset, wherein the current ephemeral keyset is a first ephemeral keyset.

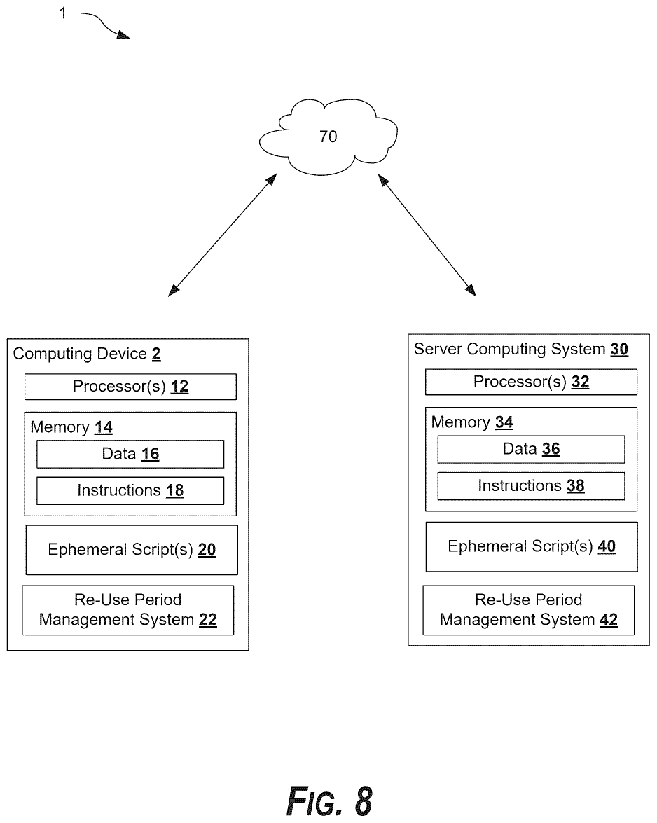

FIG. 8 is a block diagram of an example computing system that can perform according to example embodiments of the present disclosure. The system includes a computing device 2 and a server computing system 30 that are communicatively coupled over a network 70.

The computing device 2 can be any type of computing device, such as, for example, a personal computing device (e.g., laptop or desktop), a mobile computing device (e.g., smartphone or tablet), a gaming console or controller, a wearable computing device, an embedded computing device, or any other type of computing device. In some embodiments, the computing device 2 can be a client computing device. The computing device 2 can include one or more processors 12 and a memory 14. The one or more processors 12 can be any suitable processing device (e.g., a processor core, a microprocessor, an ASIC, an FPGA, a controller, a microcontroller, etc.) and can be one processor or a plurality of processors that are operatively connected. The memory 14 can include one or more non-transitory computer-readable storage media, such as RAM, ROM, EEPROM, EPROM, flash memory devices, magnetic disks, etc., and combinations thereof. The memory 14 can store data 16 and instructions 18 which are executed by the processor 12 to cause the user computing device 2 to perform operations (e.g., to perform operations implementing input data structures and self-consistency output sampling according to example embodiments of the present disclosure, etc.).

The computing device 2 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 30 can include one or more processors 32 and a memory 34. The one or more processors 32 can be any suitable processing device (e.g., a processor core, a microprocessor, an ASIC, an FPGA, a controller, a microcontroller, etc.) and can be one processor or a plurality of processors that are operatively connected. The memory 34 can include one or more non-transitory computer-readable storage media, such as RAM, ROM, EEPROM, EPROM, flash memory devices, magnetic disks, etc., and combinations thereof. The memory 34 can store data 36 and instructions 38 which are executed by the processor 32 to cause the server computing system 30 to perform operations (e.g., to perform operations implementing input data structures and self-consistency output sampling according to example embodiments of the present disclosure, etc.).

In some implementations, the server computing system 30 includes or is otherwise implemented by one or more server computing devices. In instances in which the server computing system 30 includes plural server computing devices, such server computing devices can operate according to sequential computing architectures, parallel computing architectures, or some combination thereof.

The network 70 can be any type of communications network, such as a local area network (e.g., intranet), wide area network (e.g., Internet), or some combination thereof and can include any number of wired or wireless links. In general, communication over the network 70 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

Computing device 2 can include and implement one or more ephemeral scripts 20. These scripts can manage the generation, storage, and deletion of ephemeral keysets in accordance with the key re-use periods. The scripts can automate the process of keyset serialization and ensure that the keys are securely transmitted to other computing systems involved in secure communications. Furthermore, the scripts can handle the expiration of key re-use periods by securely deleting old keysets from the memory cache and generating new ones for upcoming periods.

Computing device 2 can include a re-use period management system 22. This system is responsible for determining and controlling the key-use periods. In one example, the periods can be of fixed length and the system 22 can use a clock or timer to initiate and expire periods. In other examples, the system 22 can dynamically determine the length of each key re-use period, for example based on factors such as network traffic, system load, and security requirements. It can ensure that the key re-use periods are optimally set to balance security and performance. Thus, the re-use period management system 22 can manage the transitions between re-use periods by triggering the generation of new ephemeral keysets and the deletion of expired ones.

Server computing system 30 can include and implement one or more ephemeral scripts 40. These scripts can manage the generation, storage, and deletion of ephemeral keysets in accordance with the key re-use periods. The scripts can automate the process of keyset serialization and ensure that the keys are securely transmitted to other computing systems involved in secure communications. Furthermore, the scripts can handle the expiration of key re-use periods by securely deleting old keysets from the memory cache and generating new ones for upcoming periods.

Server computing system 30 can include a re-use period management system 42. This system is responsible for determining and controlling the key-use periods. In one example, the periods can be of fixed length and the system 42 can use a clock or timer to initiate and expire periods. In other examples, the system 42 can dynamically determine the length of each key re-use period, for example based on factors such as network traffic, system load, and security requirements. It can ensure that the key re-use periods are optimally set to balance security and performance. Thus, the re-use period management system 42 can manage the transitions between re-use periods by triggering the generation of new ephemeral keysets and the deletion of expired ones.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Also, terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method to perform periodic generation and caching of cryptographic keys for re-use with multiple communication sessions, the method comprising:
for each of a plurality of key re-use periods:
generating, by a first computing system, and in response to an initiation of the key re-use period, a current ephemeral keyset comprising an ephemeral public key and an ephemeral private key;
storing, by the first computing system, the current ephemeral keyset in a memory cache; and
using, by the first computing system, and until an expiration of the key re-use period, the current ephemeral keyset to initiate or resume one or more secure communication sessions with one or more other computing systems.

2. The computer-implemented method of claim 1, wherein each of the number of key re-use periods has a pre-defined temporal length.

3. The computer-implemented method of claim 1, wherein a length of each key re-use period is dynamically determined.

4. The computer-implemented method of claim 1, wherein, for each of the plurality of key re-use periods, the method further comprises:
in response to expiration of the current key re-use period, deleting, by the first computing system, the current ephemeral keyset from the memory cache.

5. The computer-implemented method of claim 1, wherein using, by the first computing system, and until the expiration of the current key re-use period, the current ephemeral keyset comprises re-using, by the first computing system, and until the expiration of the current key re-use period, the current ephemeral keyset to initiate or resume multiple different secure communication sessions.

6. The computer-implemented method of claim 5, wherein re-using, by the first computing system, and until the expiration of the current key re-use period, the current ephemeral keyset to initiate or resume multiple different secure communication sessions comprises re-using, by the first computing system, and until the expiration of the current key re-use period, the current ephemeral keyset to initiate or resume multiple different secure communication sessions conducted with multiple different computing systems.

7. The computer-implemented method of claim 1, wherein the one or more other computing systems are configured to generate and re-use their own ephemeral keysets over their own respective key re-use periods.

8. The computer-implemented method of claim 1, wherein the respective key re-use periods of the one or more other computing systems are asynchronous with the key re-use periods of the first computing system.

9. The computer-implemented method of claim 1, wherein:
for each of the plurality of key re-use periods, the method further comprises serializing, by the first computing system, the ephemeral public key to generate a serialized public key;
storing, by the first computing system, the current ephemeral keyset in the memory cache comprises storing, by the first computing system, the serialized public key in the memory cache; and
using, by the first computing system, and until the expiration of the key re-use period, the current ephemeral keyset to initiate or resume one or more secure communication sessions with the one or more other computing systems comprises transmitting, by the first computing system, the serialized public key to the one or more other computing systems.

10. The computer-implemented method of claim 1, wherein using, by the first computing system, and until the expiration of the key re-use period, the current ephemeral keyset to initiate or resume one or more secure communication sessions comprises using, by the first computing system, and until the expiration of the key re-use period, the current ephemeral keyset to initiate or resume one or more mutual authentication and transport encryption protocols.

11. The computer-implemented method of claim 1, wherein generating, by the first computing system, and in response to the initiation of the key re-use period, the current ephemeral keyset comprises performing, by the first computing system, and in response to the initiation of the key re-use period, a post-quantum cryptographic algorithm to generate a current post-quantum cryptographic keyset.

12. The computer-implemented method of claim 1, wherein the plurality of key re-use periods are sequential and non-overlapping.

13. The computer-implemented method of claim 1, wherein storing, by the first computing system, the current ephemeral keyset in the memory cache comprises storing, by the first computing system, the current ephemeral keyset in only a non-persistent memory cache.

14. The computer-implemented method of claim 1, wherein, for each of the plurality of key re-use periods, the method further comprises denying, by the first computing system, any attempts to initiate or resume a secure communication session that use prior ephemeral keysets associated with prior, expired key re-use periods.

15. The computer-implemented method of claim 1, wherein the ephemeral keyset comprises a Elliptic Curve Digital Signature Algorithm (ECDSA) keyset.

16. A first computing system configured to perform operations for periodic generation and caching of cryptographic keys for re-use with multiple communication sessions, the operations comprising:
for each of a plurality of key re-use periods:
generating, by the first computing system, and in response to an initiation of the key re-use period, a current ephemeral keyset comprising an ephemeral public key and an ephemeral private key;
storing, by the first computing system, the current ephemeral keyset in a memory cache; and
using, by the first computing system, and until an expiration of the key re-use period, the current ephemeral keyset to initiate or resume one or more secure communication sessions with one or more other computing systems.

17. The first computing system of claim 16, wherein each of the number of key re-use periods has a pre-defined temporal length.

18. The first computing system of claim 16, wherein a length of each key re-use period is dynamically determined.

19. The first computing system of claim 16, wherein, for each of the plurality of key re-use periods, the operations further comprise:
in response to expiration of the current key re-use period, deleting, by the first computing system, the current ephemeral keyset from the memory cache.

20. The first computing system of claim 16, wherein using, by the first computing system, and until the expiration of the current key re-use period, the current ephemeral keyset comprises re-using, by the first computing system, and until the expiration of the current key re-use period, the current ephemeral keyset to initiate or resume multiple different secure communication sessions.
